(19) United States
(12) Patent Application Publication
(10) Pub. No.: US 2013/0067447 A1
(43) Pub. Date: Mar. 14, 2013

(54) State Machine Based Package Installation

(71) Applicants: Hemchander Venkateshwara Sannidhanam, Bothell, WA (US); John M. Sheehan, Cambridge, MA (US); Zainab Hakim, Sammamish, WA (US); Edmund A. Brackett, Woodinville, WA (US); Andres Carlo Petralli, Seattle, WA (US); Ashish Awasthi, Seattle, WA (US)

(72) Inventors: Hemchander Venkateshwara Sannidhanam, Bothell, WA (US); John M. Sheehan, Cambridge, MA (US); Zainab Hakim, Sammamish, WA (US); Edmund A. Brackett, Woodinville, WA (US); Andres Carlo Petralli, Seattle, WA (US); Ashish Awasthi, Seattle, WA (US)

(73) Assignee: Microsoft Corporation, Redmond, WA (US)

(21) Appl. No.: 13/228,906

(22) Filed: Sep. 9, 2011

(51) Int. Cl. G06F 9/445; G06F 9/44

(52) U.S. Cl. 717/169; 717/175

(57) ABSTRACT

A single instance store including files for multiple packages is maintained in a computing device, each of the multiple packages including one or more components or modules for one or more applications. For each of the multiple packages, a record of a state for the package is maintained, and one or more of the multiple packages can have different ones of multiple states for different users. Based at least in part on a state machine and the state for one of the multiple packages, the one of the multiple packages is transitioned to a different state.

### BACKGROUND

Computers typically have multiple installed applications, and oftentimes run multiple applications concurrently. Computers also oftentimes have multiple users, with different applications being used by different users. This can result in frustrating situations for users in which application installation is time-consuming, and applications are installed for a user that he or she did not want to be installed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, files for multiple packages are maintained in a computing device. Each of the multiple packages includes one or more components or modules for one or more applications. For each of the multiple packages, a record of a state for the package is maintained, and one or more of the multiple packages can have different ones of multiple states for different users. Based at least in part on a state machine and the state for one of the multiple packages, the one of the multiple packages is transitioned to a different state.

In accordance with one or more aspects, one or more files of a package are stored on a storage device of a computing device, the one or more files including one or more components or modules for one or more applications. A state of staged for the package is maintained for each of multiple users of the computing device. One or more applications in the package for one user of the multiple users are registered in response to an installation request, and the state for the package is transitioned to registered for the one user while keeping the state of staged for the package for the other users of the multiple users.

### BRIEF DESCRIPTION OF THE DRAWINGS

The same numbers are used throughout the drawings to reference like features.

FIG. 1 illustrates an example system implementing the state machine based package installation in accordance with one or more embodiments.

FIG. 2 illustrates another example system implementing the state machine based package installation in accordance with one or more embodiments.

FIG. 3 illustrates example states of a package manager in accordance with one or more embodiments.

FIG. 4 is a flowchart illustrating an example process for a device implementing the state machine based package installation in accordance with one or more embodiments.

FIG. 5 is a flowchart illustrating another example process for a device implementing the state machine based package installation in accordance with one or more embodiments.

FIG. 6 illustrates an example computing device that can be configured to implement the state machine based package installation in accordance with one or more embodiments.

### DETAILED DESCRIPTION

State machine based package installation is discussed herein. An application can be distributed in different manners, such as as being part of a deployment collection that can include one or more packages having various code and associated resources, as individual files treated as a package, and so forth. A deployment engine on a computing device includes a package manager that manages installation of packages on the computing device. The package manager operates as a state machine, and can maintain different states for each package as well as for each user of the computing device. These different states allow the package manager to readily determine whether an application is installed on the computing device, as well as readily identify various other information regarding packages.

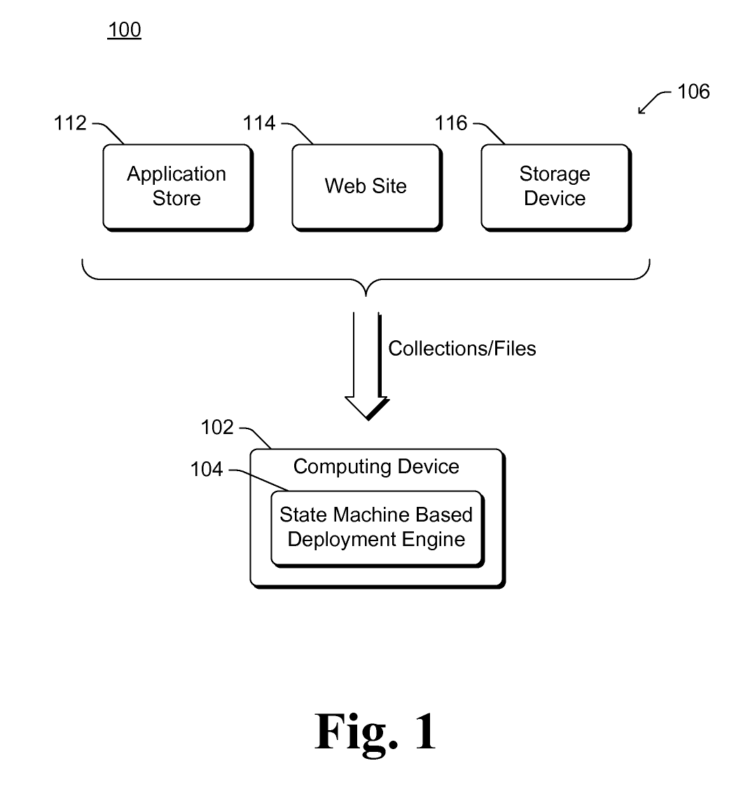

FIG. 1 illustrates an example system 100 implementing the state machine based package installation in accordance with one or more embodiments. System 100 includes a computing device 102, which can be a variety of different types of devices, such as a physical device or a virtual device. For example, computing device 102 can be a physical device such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. Computing device 102 can also be a virtual device, such as a virtual machine running on a physical device. A virtual machine can be run on any of a variety of different types of physical devices (e.g., any of the various types listed above).

Computing device 102 includes a state machine based deployment engine 104 that manages installation of applications on computing device 102. Computing device 102 treats applications as being included in a package, and a package can be received as at least part of a deployment collection or as individual files. A deployment collection refers to a collection of one or more packages that each include one or more components or modules for one or more applications, and individual files refer to individual files that include one or more components or modules for one or more applications. As part of an installation or deployment process, the individual files that are received and/or files extracted or otherwise obtained from a deployment collection are written to a storage device of computing device 102. The components or modules of an application can include binary code that is executed as part of an application or code that is interpreted or otherwise processed as part of an application, as well as resources of the application (e.g., text or images that are part of the application or other data that is part of the application, a library that is part of the application, and so forth).

Computing device 102 obtains deployment collections and/or individual files from one or more of a variety of different package sources 106. Package sources 106 can include remote sources, such as an application store 112 or a Web site 114. Remote sources can be accessed via a variety of different networks, such as the Internet, a local area network (LAN), a public telephone network, an intranet, other public and/or proprietary networks, combinations thereof, and so forth. Package sources 106 can also include local sources, such as storage device 116. Storage device 116 can be a variety of different storage devices, such as a magnetic disk, an optical disc, a Flash memory device, and so forth. Local sources can be included as part of computing device 102, can be removable devices that are coupled to and de-coupled from computing device 102, can be devices coupled to computing device 102 via a wired and/or wireless connection, and so forth.

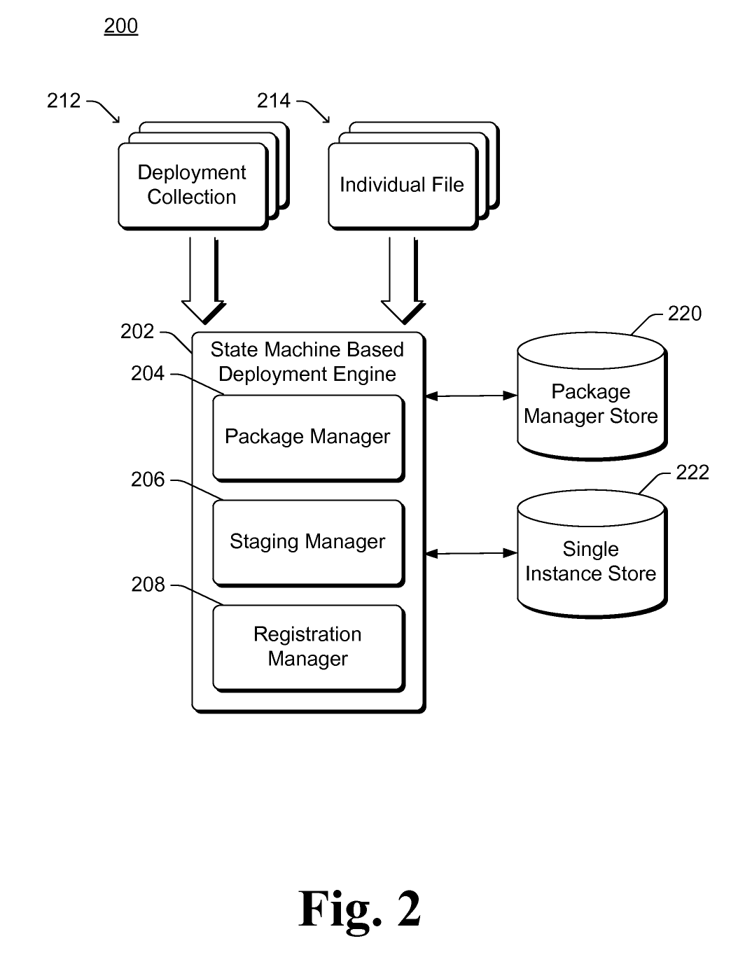

FIG. 2 illustrates an example system 200 implementing the state machine based package installation in accordance with one or more embodiments. System 200 can be implemented by, for example, a computing device 102 of FIG. 1. System 200 includes a state machine based deployment engine 202, which can be a deployment engine 104 of FIG. 1. Deployment engine 202 includes a package manager 204, a staging manager 206, and a registration manager 208. Package manager 204 is a state machine that maintains various states for packages on system 200. Each package can be in different ones of multiple states at different times, and can be in different states for different users at the same time. Staging manager 206 manages staging of packages on system 200, which generally refers to obtaining and storing the various components and modules for packages (e.g., as files) on system 200. Registration manager 208 manages registering of packages on system 200, which generally refers to configuring various settings and values for installing applications on system 200.

Deployment engine 202 can install applications in a package (which is also referred to as installing the package) on system 200 from one or more deployment collections 212 and/or one or more individual files 214. A package can be provided to deployment engine 202 as a deployment collection 212 including multiple files, or as individual (loose) files 214 that are not part of a deployment collection. Deployment engine 202 views applications as being included in a package, regardless of whether received as at least part of a deployment collection 212 or as individual files 214.

A deployment collection 212 is a collection of one or more files packaged in one of a variety of different formats. For example, deployment collection can be packaged in an AppX package format, a Zip file format, an Open Packaging Conventions (OPC) format, and so forth. Although these are example formats for deployment collections, it should be noted that the one or more files of a deployment collection can be packaged using various other formats.

Individual files refer to files that are stored separately rather than being part of a deployment collection 212. Thus, rather than being compressed, combined, or otherwise packaged in accordance with the package format of a deployment collection 212, individual files 212 exist as separate files when obtained by deployment engine 202.

Each package has an associated manifest that includes various metadata indicating actions to be taken to install the package. The manifest for a package is obtained by deployment engine 202 regardless of whether the package is received as part of a deployment collection 212 or as one or more individual files 214. The manifest for a package can be included in a deployment collection 212 that includes the package, can be included in one or more files 214 for that package, can be obtained separately from another source (e.g., a source 106 of FIG. 1), and so forth. The manifest associated with a package can identify individual files 214 that are part of the package, can identify how to extract or otherwise obtain files that are part of the package from a deployment collection, and so forth. The manifest associated with a package identifies how to install the package, such as which files are to be written to a storage device, a folder or directory structure to use in writing the files to a storage device (e.g., where on the storage device files are to be written), what configuration values are to be set (e.g., in an operating system registry or store), and so forth. The manifest associated with a package can also include dependency information for the package, identifying other packages (if any) that that package is dependent on.

Deployment engine 202 also maintains a package manager store 220 and a single instance store 222. Package manager store 220 and single instance store 222 are maintained on one or more storage devices of the computing device implementing system 200, such as a Flash memory device, a magnetic disk, and so forth. Single instance store 222 maintains files for packages. Regardless of whether the files of a package are received as part of a deployment collection 212 (and regardless of the format of the deployment collection) or as one or more individual files 214, the files of the package can be stored in single instance store 222 using the directory or folder structure indicated in the manifest associated with the package. In some situations, individual files 214 are already stored in directories or folders that are part of single instance store 222 when deployment engine 202 obtains the files 214, and thus such files 214 need not be re-stored by deployment engine 202. In other situations, individual files 214 are stored elsewhere on one or more storage devices of the computing device implementing system 200, and need not be stored in single instance store 222.

Package manager store 220 stores various information regarding packages and their states for one or more users, including an identification of each of multiple packages (e.g., a package identifier of each package) and the manifests associated with those packages. The package identifier in store 220 is maintained or otherwise indicated as being associated with the or more applications installed from the identified package.

Each package has an associated package identifier, which is typically included in the manifest associated with the package but can alternatively be included in other locations. The package identifier allows different packages to be distinguished from one another, and can identify the package in various manners. In one or more embodiments, the package identifier includes various elements, such as a name, a publisher, an architecture, a resource identifier, and/or a version. The name is a name assigned to the package by the developer of the package. The developer can choose any name they desire. The publisher is a name of the publisher of the package, which is typically the developer or distributor of the package. The publisher can identify various entities such as a corporation, an individual, etc. The architecture refers to the processor and/or device architecture with which the components or modules of the package are designed to operate. The developer can choose one or more architecture identifiers to include as the architecture. Various different processor and/or device architectures can be identified, such as an x86 architecture, an x64 architecture, a RISC (reduced instruction set computer architecture), and so forth.

The version is a version of the package. The developer can choose any versioning indications (e.g., numeric sequences, alphanumeric sequences, etc.) that they desire. The resource identifier can be any of a variety of different values or attributes identifying characteristics of the package. The developer can choose any characteristics that they desire, such as the country or geographic region in which the components or modules of the package are designed to operate, the language (e.g., English, French, Japanese, etc.) that the components or modules of the package use, a form factor (e.g., desktop/laptop, tablet/slate, etc.) for which the components or modules of the package are designed to operate, one or more screen resolutions for which the components or modules of the package are designed to operate, whether the package includes trial versions or fully licensed versions of applications, and so forth.

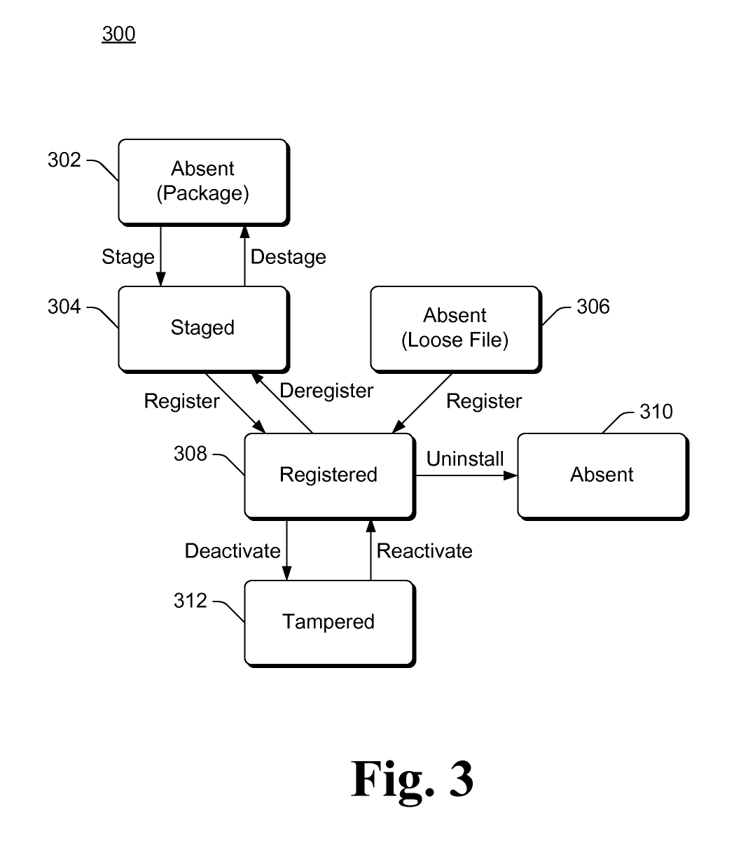

FIG. 3 illustrates example states 300 of a package manager (e.g., package manager 204 of FIG. 2) in accordance with one or more embodiments. FIG. 3 is discussed with reference to the elements of FIG. 2. The example states 300 include an absent (package) state 302, a staged state 304, an absent (loose file) state 306, a registered state 308, an absent state 310, and a tampered state 312.

Package manager 204 transitions between states 302 in response to particular events for a package, keeping track of the state of each package for one or more users of the computing device implementing system 200. If there are multiple users of the computing device implementing system 200 then each package can be in different states for different users at the same time. However, it should be noted that package manager 204 uses and transitions between states 302 even if there is a single user of the computing device implementing system 200.

Package manager 204 maintains and updates the state of each package for one or more users, although other components or modules can obtain such states from package manager 204. As used herein, a user refers to a user account that an individual uses to logged into the computing device implementing system 200. It should be noted that different individuals can log into the computing device using the same user account and thus are viewed as the same user. Similarly, the same individual can log into the computing device using different users accounts and thus is viewed as different users.

The absent (package) state 302 indicates that the files of the deployment collection are not stored on the computing device implementing system 200. The manifest associated with the package could be included on the computing device, but typically is not. Generally, package manager 204 has little if any knowledge regarding packages in absent (package) state 302.

The absent (loose file) state 306 indicates that the individual files are not stored on the computing device implementing system 200. The package manager 204 has little if any knowledge regarding packages in absent (loose file) state 306. The absent (loose file) state 306 is similar to the absent (package) state 302, although the state that is transitioned to from state 306 is different than the state that is transitioned to from state 302. Thus, states 302 and 306 can be viewed as the same state, but transitioning to a different state based on whether the files of the package are included in an application package or are loose files. A package in state 302 or 306 is in the same state for all users of the computing device.

The staged state 304 indicates that the files of the package are stored on the computing device implementing system 200. These files are stored in single instance store 222. However, although the files are stored on the computing device, in the staged state 304 the package (and thus applications of the package) is not yet installed on the computing device. A package can be in staged state 304 for some users, but not for other users.

The registered state 308 indicates that the package (and thus the one or more applications in the package) is registered for a particular user on the computing device. Various configuration values are set (e.g., in an operating system registry or store), particular directories or folders are created, and so forth as indicated in the manifest associated with the package. Once in the registered state for a particular user, the package is referred to as installed on the computing device for that particular user. A package can be in registered state 308 for some users, but not for other users.

The absent state 310 indicates that the application files are not stored on the computing device implementing system 200. The package manager 204 has little if any knowledge regarding packages in absent state 310. The absent state 310 is similar to the absent (package) state 302 and the absent (loose file) state 306, and becomes one of states 302 or 306 if an application were to be reinstalled on the computing device. Thus, state 310 can be viewed as state 302 and/or state 306. A package in state 310 is in state 310 for all users of the computing device.

The tampered state 312 indicates that a package that has been installed on the computing device implementing system 200 has been changed. This change can be the result of a malicious program or other program, and accordingly a check is made (e.g., by deployment engine 202 or another component or module of the computing device) as to whether an application installed from the package can still be run. A package in state 312 is in state 312 for all users of the computing device.

During operation, a request to install a package on the computing device implementing system 200 is received. The request is received for a user, which is typically (but need not be) the user logged into the computing device at the time the request is received. The request can be received from a user (e.g., as a selection of a particular application or package to install), from another component or module of the computing device, from a source 106 of FIG. 1 (e.g., an application store), and so forth. In response to the request, package manager 204 obtains the package identifier of the package including the package to be installed. The package identifier can be obtained in different manners, such as being provided to package manager 204 from the source that received the user selection for an application or package to be installed (e.g., an application store or other source 106 of FIG. 1), being obtained from a manifest provided to package manager 204 (e.g., from an application store or other source 106 of FIG. 1), and so forth.

Package manager 204 accesses package manager store 220 to identify the state of the package for which installation is requested. Package manager 204 proceeds based on the state of the package for the user. If package manager store 220 does not yet include the package identifier of the package for which installation is requested (e.g., the package is a new package being installed on the computing device implementing system 200), then package manager 204 treats the package as being in the absent (package) state 302 if the package is received as part of a deployment collection, or as being in the absent (loose file) state 306 if the package is received as individual files.

If the state of the package for the user is the absent (package) state 302, then package manager 204 transitions to the staged state 304 for that package and user by staging the package. As part of staging the package, staging manager 206 obtains the package from one or more sources (e.g., sources 106 of FIG. 1) and stores the files of the package in single instance store 222. The files can be stored in one or more folders or directories, and the appropriate folders or directories can be created if not already present, as indicated by the manifest associated with the package. Various files can also be decompressed, decrypted, and so forth prior to being stored in single instance store 222 as indicated in the manifest associated with the package. Additionally, as part of the staging process package manager 204 stores various information regarding the package, including an identification of the package and the manifest associated with the package, in package manager store 220. In response to this information being stored in package manager store 220, and the files being stored in single instance store 222, package manager 204 transitions to the staged state 304 for that package and user.

It should be noted that the package can remain in the staged state for an indefinite amount of time. If package manager 204 transitioned to the staged state 304 in response to a request to install a package for a user, then package manager 204 proceeds to register the application and transition to registered state 308 for the package for that user. However, the state of the package remains in the staged state 304 for other users that have not requested that the package be installed.

Additionally, package manager 204 can transition from staged state 304 to absent (package) state 302 in response to a request to destage the package. Such a request can be received in various manners, such as from another component or module operating to clean up single instance store 222, from a user, and so forth. As part of destaging the package, staging manager 206 deletes the files of the package from single instance store 222. Which files are included in the package can be identified in various manners, such as based on the manifest associated with the package, based on a mapping of files to package identifiers maintained in package manager store 220, and so forth. Additionally, as part of the destaging process package manager 204 deletes previously stored information regarding the package (e.g., an identification of the package and the manifest associated with the package) from package manager store 220. In response to this information being deleted from package manager store 220, and the files being deleted from in single instance store 222, package manager 204 transitions to the absent (package) state 302 for the package.

If the state of the package for the user is the staged state 304, then package manager 202 transitions to the registered state 308 by registering the package. Registering the package generally refers to publishing the package as being available for use by the user, and letting the operating system know how to make use of the features of the package. As part of registering the package, registration manager 208 performs various actions such as setting various configuration values (e.g., in an operating system registry or store), creating and/or configuring particular directories or folders, and so forth as indicated in the manifest associated with the package. Registration manager 208, by performing these various actions, registers the one or more applications in the package for running on the computing device for the user for which installation is being performed. In response to these actions being performed, package manager 204 transitions to the registered state 308 for the package for the user for which installation is being performed.

If the state of the package for the user is the absent (loose file) state 306 rather than absent (package) state 302, then package manager 204 transitions to the registered state 308 by registering the package. This is similar to the registration of a package when transitioning from staged state 304 to registered state 308, although the files are individual files in single instance store 222 (or elsewhere on one or more storage devices of the computing device implementing system 200) rather than being included as part of a package in a deployment collection. The individual files are treated as being part of package as discussed above, with an indication of one or more files to install, as well as other actions to take (e.g., setting configuration values, creating directories), being provided to package manager 202. The indication can be a manifest or other record from which package manager 204 can generate a manifest. If a manifest is not provided to package manager 204, then package manager 204 generates a manifest for the individual files, including in the manifest identifiers of the individual files as well as the various actions to take to register the individual files (and treat those individual files as a package).

As part of registering the package from the absent (loose file) state 306, registration manager 208 performs various actions such as setting various configuration values (e.g., in an operating system registry or store), creating and/or configuring particular directories or folders, and so forth as indicated in the manifest. Registration manager 208, by performing these various actions, registers the one or more applications in the individual files on the computing device for the user for which installation is being performed. In response to these actions being performed, package manager 204 transitions to the registered state 304 for the package for the user for which installation is being performed.

After a package is registered on the computing device, various other events can cause package manager 204 to transition to a different state for a package. Package manager 204 can transition to a different state for all users, or alternatively only for particular users. In one or more embodiments, package manager 204 uninstalls a package in response to a request to uninstall the package or the one or more applications included in a package. The request can be, for example, a user request, a request received from another component or module of the computing device but associated with a user, and so forth.

In response to a request to uninstall the package, package manager 204 checks the state of the package. If the package is in the registered state 308 for the user for which the uninstall request is received, and is not in the registered state 308 for any other user of the computing device, then package manager 204 uninstalls the package. As part of uninstalling the package, package manager 204 deregisters the package for the user for which the uninstall request is received. As part of deregistering the package for the user, deployment engine 202 performs various actions to undo the actions performed when registering the package. For example, deployment engine 202 can change or delete various configuration values (e.g., in an operating system registry or store), delete and/or configure particular directories or folders, and so forth. These actions to take to deregister the package can be indicated in the manifest or determined in other manners (e.g., a record of actions taken to register a package can be maintained by registration manager 208), and those actions can be undone (e.g., settings returned to previous values, settings deleted, etc.). Also as part of uninstalling the package, staging manager 206 deletes the files of the package from single instance store 222 and package manager 204 deletes previously stored information regarding the package from package manager store 220, analogous to the destaging process discussed above. In response to the package being deregistered, the information being deleted from package manager store 220, and the files being deleted from in single instance store 222, package manager 204 transitions to the absent state 310 for the package for all users.

However, if the package is in the registered state for one or more other users of the computing device, then package manager 204 does not uninstall the package. Rather, package manager 204 deregisters the package for the user for which the uninstall request is received. In response to the deregistration being performed, package manager 204 transitions to the staged state 304 for the package for the user for which the uninstall request is received.

In one or more embodiments, package manager 204 is queried (e.g., by an operating system of the computing device) in response to a request to run an application for a user. Package manager 204 obtains the state for that user of the package that includes the application from package manager store 220 and returns the state to the requester, allowing the requester to determine whether and/or how to run the application based on the returned state. Alternatively, package manager 204 can return to the requester an indication, based on the state for that user of the package that includes the application, whether and/or how to run the application.

Additionally, in one or more embodiments, package manager 204 deactivates a package in response to a request from a security component or module of the computing device implementing system 200. The security component or module monitors one or more files of packages that are registered on the computing device for one or more users, and detects when changes are made to those files. The one or more files that are monitored can be identified in different manners, such as being identified in the manifest associated with the package, being files of particular types (e.g., including executable code), and so forth.

Changes to a file can be detected in different manners. For example, an original hash value can be generated by inputting the file to a hash function when the package is staged or registered on the computing device. These hash values can be stored in a secure manner (e.g., in a location accessible only to the security component or module, in a digitally signed manifest, in an encrypted form, etc.), and re-generated at a later time. If subsequently generated hash values based on the files are not the same as the original hash value, then the file has been changed. Various hash functions can be used, such as a message authentication code (MAC) or hash-based message authentication code (HMAC), or other key derivation function. For example, the file can be input to an SHA-1 (Secure Hash Algorithm 1) function, an SHA-128 or SHA-256 function, and so forth, the output of which is the hash value.

In response to a request to deactivate a package, package manager 204 transitions to the tampered state 312 for the package. While in the tampered state, applications in the package are not run. Various remedial measures can be taken while in the tampered state, such as re-staging the package, uninstalling the package, modifying the package (e.g., to undo changes made by malicious code), and so forth. After the appropriate remedial measures are taken, package manager 204 is requested (e.g., by the security component or module) to reactivate the package. In response to the request to reactivate the package, package manager 204 transitions to the registered state 308 for the package for users for which the package was in the registered state 308 prior to transitioning to the tampered state 312. For users for which the package was in the staged state 304 prior to transitioning to the tampered state 312, package manager 204 transitions to the staged state 304.

It should be noted that situations can arise in which a package is part of a multi-package product, with one or more packages being dependent on one or more other packages. One package is dependent on another package if the one package relies on that other package to be present (registered) in order for an application in the one package to function correctly when running In such situations, deployment engine 202 proceeds as discussed above with each of the multiple packages in the multi-package product. For example, if a request to install a multi-package product is received, deployment engine 202 proceeds to register (or stage and register) each of the multiple packages in the multi-package product. In one or more embodiments, deployment engine 202 proceeds to register each package in the staged state only after all of the packages in the multi-package product are in the staged state.

It should also be noted that while installing a package on a computing device, various failures can occur (e.g., due to a loss of power, due to a malfunctioning component or module, etc.). Package manager maintains the status of the installation of a package as the package is being installed to facilitate recovery from such failures. In one or more embodiments, package manager 204 sets a deployment flag to indicate that installation of a package has started, and also stores a record of the one or more packages being installed. This deployment flag and record are stored in package manager store 220 or elsewhere in a location that is persisted in the event of a power loss or computing device reset. In response to staging and registering of the package being completed, package manager 204 clears the deployment flag to indicate that installation of the package has been completed.

When deployment engine 202 runs (e.g., in response to a request to install a package, when the computing device is booted, etc.), package manager 204 checks the deployment flag. If the deployment flag is set, then package manager 204 knows that installation of the one or more packages did not complete. For each of the one or more packages that is in the staged state 304, package manager 204 notifies registration manager 208 to proceed with registering the package. For each of the one or more packages that is in an absent (package) state 302 or absent (loose file) state 306, package manager 204 notifies staging manager 206 to delete any files of the package (whether from a deployment collection 212 or individual files 214) in single instance store 222, and restart the staging of the package or obtaining of individual files 214.

Although particular states are illustrated in FIG. 3, package manager 204 is extendable and can be extended to include one of more of a variety of additional states. These states can be related to installation of packages, uninstallation of packages, running of applications in packages, and so forth.

In one or more embodiments, package manager 204 includes a trial state, which indicates that the one or more applications of the package are licensed as a trial version. Package manager 204 transitions to the trial state for a package in response to an indication (e.g., from another component or module, in a manifest associated with the package, etc.) that the package is licensed as a trial version. Package manager 204 transitions from the trial state to registered state 308 (or a fully licensed state) for the package in response to an indication that the package has become licensed as a trial version, or transitions to the absent state 310 if uninstalled (e.g., due to a trial period expiring). A package can be in a trial state for all users, or alternatively in a trial state for some users but not for other users.

In one or more embodiments, package manager 204 includes an update state, which indicates that the package is to be updated before applications from the package are run. Package manager 204 transitions to the update state for a package in response to an indication (e.g., from another component or module, from a source 106 of FIG. 1, etc.), that an update to the package is available. While in the update state, applications in the package are not run. Package manager 204 transitions from the update state to staged state 304 for the package in response to an updated package being staged on the computing device, and then to a registered state 308 in response to the update package being registered on the computing device.

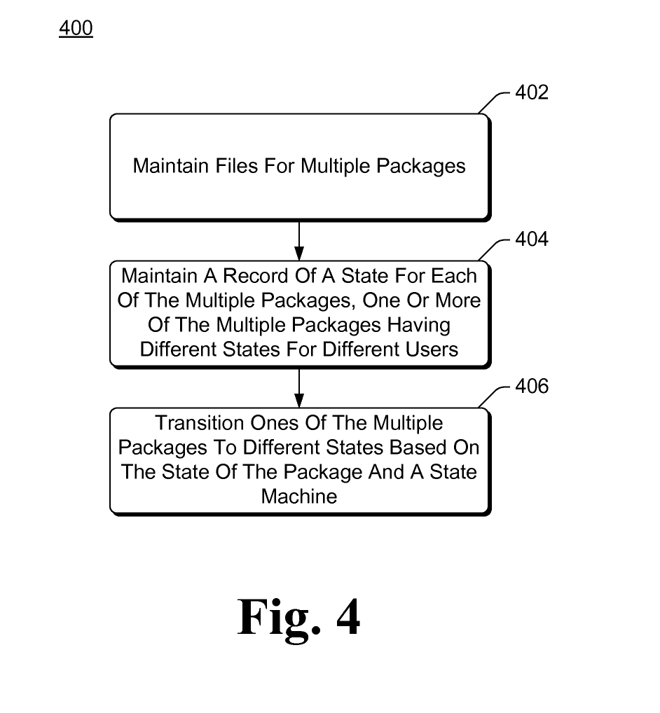

FIG. 4 is a flowchart illustrating an example process 400 for a device implementing the state machine based package installation in accordance with one or more embodiments. Process 400 is carried out by a device, such as computing device 102 of FIG. 1, or a device implementing system 200 of FIG. 2, and can be implemented in software, firmware, hardware, or combinations thereof. Process 400 is shown as a set of acts and is not limited to the order shown for performing the operations of the various acts. Process 400 is an example process for implementing the state machine based package installation; additional discussions of implementing the state machine based package installation are included herein with reference to different figures.

In process 400, files for multiple packages are maintained (act 402). Each package includes one or more components or modules for one or more applications as discussed above. The files for the packages can be received as individual files and/or as part of deployment collections (in various formats) as discussed above. The files can be maintained in a single instance store. Alternatively, some files (e.g., individual (loose) files) need not be maintained in the single instance store, but can be located elsewhere on one or more storage devices of the device implementing process 400.

A record of a state for each of the packages is also maintained (act 404). One or more of these multiple packages can have different ones of multiple states for different users, as discussed above.

Ones of the multiple packages are transitioned to different states based at least in part on a state machine and the state of the package (act 406). The transition can occur in response to various requests or events as discussed above.

The state machine based package installation techniques discussed herein support various usage scenarios. An application is identified by the package identifier of the package that includes the application, and different states can be maintained for these package identifiers for different users of a computing device. Thus, a package can be in a staged state for some users (and thus the application not installed for those users), but in a registered state for other users (and thus the application installed for those users). However, if a user for which the package is in the staged state desires to have the application installed, the package is registered and the state for that user is transitioned to the registered state. Additional files need not be copied onto the computing device because the package has already been staged.

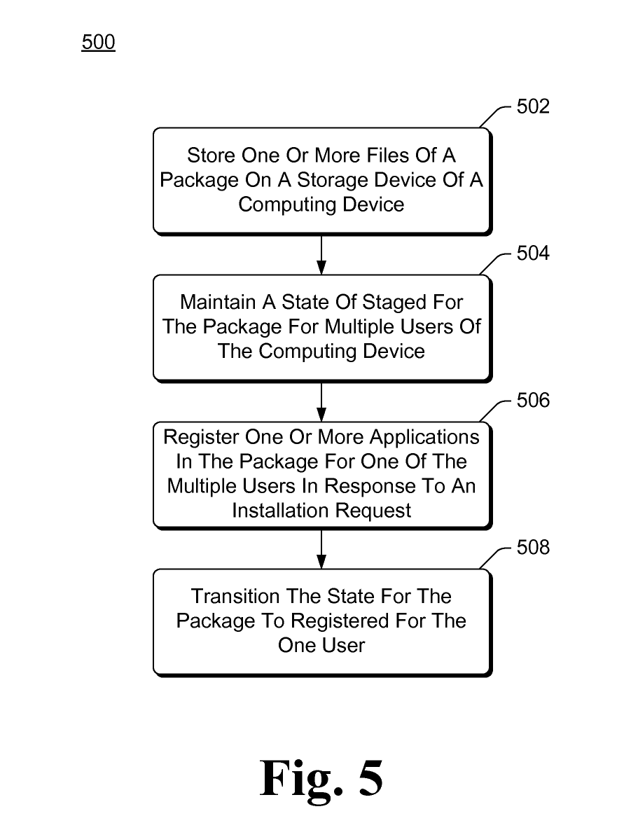

FIG. 5 is a flowchart illustrating another example process 500 for a device implementing the state machine based package installation in accordance with one or more embodiments. Process 500 is carried out by a device, such as computing device 102 of FIG. 1, or a device implementing system 200 of FIG. 2, and can be implemented in software, firmware, hardware, or combinations thereof. Process 500 is shown as a set of acts and is not limited to the order shown for performing the operations of the various acts. Process 500 is an example process for implementing the state machine based package installation; additional discussions of implementing the state machine based package installation are included herein with reference to different figures.

In process 500, one or more files of a package are stored on a storage device of a computing device (act 502). The one or more files include one or more components or modules for one or more applications as discussed above.

A state of staged is maintained for the package for each of multiple users of the computing device (act 504). The staged state indicates that files of the one package are stored on the computing device but the package is not installed on the computing device as discussed above.

In response to an installation request, one or more applications in the package are registered for one of the multiple users (act 506). The state for the package is transitioned to registered for the one user while keeping the state of staged for the package for the other users (act 508). The registered state indicates that the package is registered and installed for the user. The state of the package can similarly be transitioned to registered for ones of other users in response to installation requests and registration of the package for those ones of the other users.

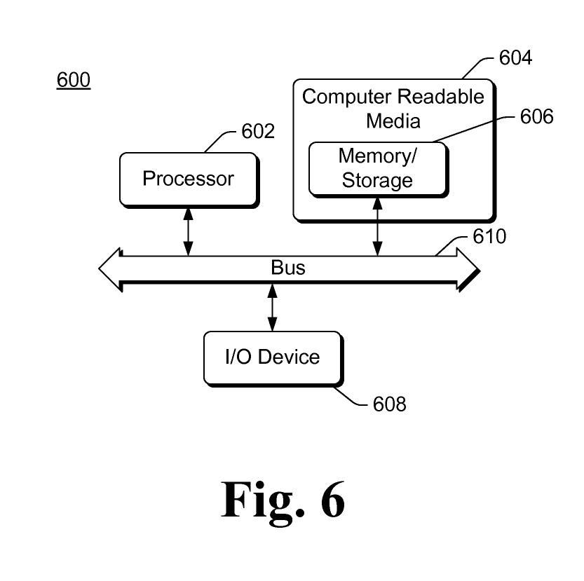

FIG. 6 illustrates an example computing device 600 that can be configured to implement the state machine based package installation in accordance with one or more embodiments. Computing device 600 can, for example, be computing device 102 of FIG. 1, or implement system 200 of FIG. 2.

Computing device 600 includes one or more processors or processing units 602, one or more computer readable media 604 which can include one or more memory and/or storage components 606, one or more input/output (I/O) devices 608, and a bus 610 that allows the various components and devices to communicate with one another. Computer readable media 604 and/or one or more I/O devices 608 can be included as part of, or alternatively may be coupled to, computing device 600. Processor 602, computer readable media 604, one or more of devices 608, and/or bus 610 can optionally be implemented as a single component or chip (e.g., a system on a chip). Bus 610 represents one or more of several types of bus structures, including a memory bus or memory controller, a peripheral bus, an accelerated graphics port, a processor or local bus, and so forth using a variety of different bus architectures. Bus 610 can include wired and/or wireless buses.

Memory/storage component 606 represents one or more computer storage media. Component 606 can include volatile media (such as random access memory (RAM)) and/or nonvolatile media (such as read only memory (ROM), Flash memory, optical disks, magnetic disks, and so forth). Component 606 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 602. It is to be appreciated that different instructions can be stored in different components of computing device 600, such as in a processing unit 602, in various cache memories of a processing unit 602, in other cache memories of device 600 (not shown), on other computer readable media, and so forth. Additionally, it is to be appreciated that the location where instructions are stored in computing device 600 can change over time.

One or more input/output devices 608 allow a user to enter commands and information to computing device 600, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communication media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Computer storage media refer to media for storage of information in contrast to mere signal transmission, carrier waves, or signals per se. Thus, computer storage media refers to non-signal bearing media, and is not communication media.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 6. In the case of hardware implementation, the module or component represents a functional block or other hardware that performs specified tasks. For example, in a hardware implementation the module or component can be an application-specific integrated circuit (ASIC), field-programmable gate array (FPGA), complex programmable logic device (CPLD), and so forth. The features of the state machine based package installation techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
maintaining, in a computing device, files for multiple packages, each package including one or more components or modules for one or more applications;
maintaining, for each of the multiple packages, a record of a state for the package, one or more of the multiple packages having different ones of multiple states for different users; and
transitioning, based at least in part on a state machine and the state for one of the multiple packages, to a different state for the one of the multiple packages.

2. A method as recited in claim 1, the maintaining files comprising maintaining the files for each of the multiple packages regardless of a format of a deployment collection in which each of the multiple packages was received.

3. A method as recited in claim 1, the maintaining files comprising maintaining the files for each of the multiple packages regardless of whether the files were received as individual files or as part of a deployment collection.

4. A method as recited in claim 3, the files for the one of the packages having been received as individual files, and the transitioning comprising transitioning the one package to a registered state in response to registering the one package.

5. A method as recited in claim 3, the files for the one of the multiple packages having been received as individual files, and the files for another of the multiple packages having been received as part of the deployment collection.

6. A method as recited in claim 1, further comprising one or more other of the multiple packages having a same one of the multiple states for different users.

7. A method as recited in claim 1, the transitioning comprising transitioning, in response to an installation request for a user, to a staged state for the one package for all users of the computing device, the staged state indicating that files of the one package are stored on the computing device but the package is not installed on the computing device.

8. A method as recited in claim 7, the transitioning further comprising transitioning, in response to the installation request for the user, to a registered state for the one package for the user while keeping the staged state for the one package for the other users of the computing device, the registered state indicating that the package is registered and installed for the user.

9. A method as recited in claim 1, the transitioning further comprising transitioning to a trial state for the one package, the trial state indicating that one or more applications of the one package are licensed as a trial version.

10. A method as recited in claim 1, the transitioning further comprising transitioning to a tampered state for the one package, the tampered state indicating that one or more files of the one package have been changed, and that the one or more applications in the one package cannot be run.

11. A method as recited in claim 1, the transitioning further comprising transitioning to an update state for the one package, the update state indicating that the one package is to be updated before one or more applications in the package are run.

12. A method as recited in claim 1, the state machine being extendable to include one or more additional states.

13. One or more computer storage media having stored thereon multiple instructions that, when executed by one or more processors of a computing device, cause the one or more processors to:
store one or more files of a package on a storage device of the computing device, the one or more files including one or more components or modules for one or more applications;
maintain a state of staged for the package for each of multiple users of the computing device;
register, in response to an installation request, one or more applications in the package for one user of the multiple users; and
transition the state for the package to registered for the one user while keeping the state of staged for the package for the other users of the multiple users.

14. One or more computer storage media as recited in claim 13, the multiple instructions further causing the one or more processors to transition the state for the package to one or more additional states in response to one or more additional events.

15. One or more computer storage media as recited in claim 13, the multiple instructions further causing the one or more processors to transition to a trial state for the package, the trial state indicating that the one or more applications of the package are licensed as a trial version.

16. One or more computer storage media as recited in claim 13, the multiple instructions further causing the one or more processors to transition to a tampered state for the package, the tampered state indicating that the one or more files of the package on the storage device have been changed, and that the one or more applications in the package cannot be run.

17. One or more computer storage media as recited in claim 13, the multiple instructions further causing the one or more processors to transition to an update state for the package, the update state indicating that the package is to be updated before the one or more applications in the package are run.

18. One or more computer storage media as recited in claim 13, the instructions causing the one or more processors to store the one or more files comprising instructions causing the one or more processors to store the one or more files regardless of whether the one or more files were received as individual files or as part of a deployment collection.

19. One or more computer storage media as recited in claim 13, the multiple instructions implementing a state machine that transitions to different ones of multiple states for the package, the state machine being extendable to include one or more additional states.

20. A method comprising:
storing, in a single instance store of a computing device, one or more files of a package regardless of whether the one or more files were received as individual files or as part of a deployment collection, the one or more files including one or more components or modules for one or more applications;
maintaining a state of staged for the package for each of multiple users of the computing device, the staged state indicating that files of the package are stored on the computing device but the package is not installed on the computing device;
registering, in response to an installation request for one user of the multiple users, one or more applications in the package for the one user; and
transitioning the state for the package to registered for the one user while keeping the state of staged for the package for the other users of the multiple users, the registered state indicating that the package is installed for the user.
